(19) United States
(12) Patent Application Publication
(10) Pub. No.: US 2017/0364527 A1
(43) Pub. Date: Dec. 21, 2017

(54) SYSTEM AND METHOD CONFIGURED TO EXECUTE DATA MODEL TRANSFORMATIONS ON DATA FOR CLOUD BASED APPLICATIONS

(71) Applicants: Michael Adler, Nurnberg (DE); Amit Verma, Erlangen (DE)

(72) Inventors: Michael Adler, Nurnberg (DE); Amit Verma, Erlangen (DE)

(21) Appl. No.: 15/628,398

(22) Filed: Jun. 20, 2017

(30) Foreign Application Priority Data
Jun. 20, 2016 (EP) 16175174.8

(51) Int. Cl. G06F 17/30; H04L 29/06

(52) U.S. Cl. CPC G06F 17/30103; H04L 69/08; G06F 17/30507; G06F 17/30525

(57) ABSTRACT

A method and a system to expose a common data model in a wider range of data model specific views by using a meta-data store, a load balancer, model router, and model transformer are provided.

This application claims the benefit of EP 16175174.8, filed on Jun. 20, 2016, which is hereby incorporated by reference in its entirety.

### BACKGROUND

The present embodiments relate to the area of cloud based industrial data analytics and applications. Typically data from field level devices and systems in an industrial automation is collected and transferred to a cloud for analytics. A cloud is a network device with a cloud computing infrastructure (e.g., a cloud). Cloud computing infrastructure may be any infrastructure that allows shared computing services to be accessed and utilized by cloud-capable devices. The cloud includes one or more communications network. In some cases, the cloud may be provided by a cloud provider as a platform-as-a-service (PaaS), and the services may reside and execute in the cloud as a cloud-based service. Cloud services may generally include, but are not limited to, data storage, data analysis, control applications (e.g., applications that may generate and deliver control instructions to industrial devices based on analysis of near real-time system data or other factors), visualization applications such as cloud-based HMIs, reporting applications, or other such cloud-based applications. The cloud includes data persistence and management, application development and run time environment, and a set of applications that analyze data to provide insights for production enhancement, predictive maintenance, energy and process optimization, product life-cycle management, etc.

Common expressions like HTTP, etc. are not separately explained. These are common knowledge in the world of software.

FIG. 1 shows an example of the prior art. Data from field level devices and systems in an industrial automation 10 is collected and transferred to the cloud 5 for analytics. A cloud based application is an application hosted by cloud or having access to the cloud.

The industrial domain is characterized by a number of standard and vertical specific data standards. There are open standards driven by organizations like IEEE, ANSI/ISA, ISO, IEC, OPC and many more. Also, there are many niche standards that are evolving from vendor specific solutions. Some examples of domain specific standards are BACNet (BACnet=communications protocol for building automation and control networks) with a Bacnet-Data-Source 1 or OPC (Open Platform Communications (OPC)=series of standards and specifications for industrial telecommunication) with an OPC-Data-Source 2. Further, not shown or explained in detail, domain specific standards are OMAC PakML (for packaging machinery), ISO 15926 (for oil and gas industry), IEC 61850 (for electrical substation automation), etc. The data is collected via a data-collection-agent 3, then transmitted to a proprietary-interface 6. Afterwards, the data is transmitted to a common cloud data model 4.

One of the fundamental advantages of a cloud based data analytics approach is that the data collected from different standards may be normalized or standardized in a common cloud data model 4 implemented in the cloud 5. This makes the analytics applications 7 running in the cloud agnostic to the underlying data standards. Applications 7 once developed for the common cloud data model 4 may provide analytics for data collected from different standards. This, however, is true mainly for newly developed applications.

Unfortunately, there is often a need to port legacy applications to the cloud 5 in order to get quickly started with the cloud based use cases.

In FIG. 1, an application 7 that provides an algorithm to optimize the machine parameters, obtained via OPC, OPC-UA (Open Platform Communications-Unified Architecture) interface from the machine controller (e.g., the agent 3) to induce the quality of the finished product, is shown. To port this application 7 to the cloud 5 as a cloud-based application 7, the application 7 is to be re-developed so as to use the cloud data standard, instead of the OPC data standard from the agent 3. This leads to major re-development efforts.

To get quickly started with the cloud based use cases, there is often a need to port legacy applications 9 to the cloud 5.

Some legacy application 9 that provides, for example, also an algorithm to optimize the machine parameters is considered, whereas the machine parameters are given, for example, in a publish-subscribed data source structure 13. These parameters are obtained via OPC-interface 8, to induce the quality of the finished product by the cloud-based application 7. Before porting this application to the cloud 5, the application is to be re-developed so as to use the cloud data standard (e.g., the common cloud data model 4) instead of the OPC data standard provided in publish-subscribed data source structure 13. This leads to major re-development efforts. If the above application may access data from other machines (with different data standards), in the same OPC data standard, the application may be used to fulfill a broader range of use cases.

In another use case, there are onsite legacy applications 11 that are running onsite locally, from where data is collected. These onsite legacy applications 11 may also require a systematic access to the cloud based application for local data analytics and reporting functions. The advantage of having onsite legacy applications 11 access the cloud based application is that in this way, the onsite legacy applications 11 may access data from heterogeneous automation systems via the cloud 5 in a unified manner. Also here this results in major re-development efforts.

For the cloud providers, the legacy applications 11 are to be re-developed by implementing the new data models/standards of the given cloud 5. Data model transformers or protocol convertors (e.g., BACNet (building automation and control networks communication protocol) to OPC or OPC to Modbus, etc.) are present in the field level for connecting homogenous automation systems, but data model transformations for cloud based applications are non-existent.

### SUMMARY AND DESCRIPTION

The scope of the present invention is defined solely by the appended claims and is not affected to any degree by the statements within this summary.

Technologies known in the prior art, like ETL (Extract, Transform, Load) and DMT (Data Model Transformation), do not provide model transformation for application based data queries in cloud environments, as the prior art only refers to schema mapping technology and data field oriented protocol mappings.

The present embodiments may obviate one or more of the drawbacks or limitations in the related art. For example, a system configured to execute standard/data model transformations for cloud based applications is provided. As another example, a method configured to execute standard/data model transformation for cloud based applications is provided.

A system configured to execute data model transformations on data for cloud based applications includes a computer device with a cloud infrastructure having a data store. The data store has data of interest, whereas the data of interest is stored in a cloud storage data model. The system includes a cloud-based application that is configured to query the data of interest by a request in a desired data protocol based on a desired data model structure. The system also includes a meta-data store that at least includes the meta data of the data of interest, and a load balancer with a cloud infrastructure. The load balancer is configured for receiving the request and for routing the request. The system also includes a model router that is configured for receiving the routed request, for identifying the desired data protocol, and for transmitting the request based on the identified desired data protocol to a model transformer. The model transformer is configured for receiving the transmitted request and performing the data model transformation by: accessing the data of interest in the data store and the meta data of data of interest in the meta-data store; accessing a transformation rules database that contains rules for each specific transformation between the cloud storage data model and the desired data protocol; and determining a response based on the rules and based on existing composed information in the data store and in the meta-data store.

A method configured to execute data model transformations on data for cloud based applications includes providing a computer device with a cloud infrastructure having a data store, providing data of interest in the data store, whereas the data of interest is stored in a cloud storage data model, and providing a cloud based application that is configured to query the data of interest by a request in a desired data protocol based on a desired data model structure. The method also includes providing a meta-data store that at least includes the meta data of the data of interest, and providing a load balancer with a cloud infrastructure that is configured for receiving the request and for routing the request. The method includes providing a model router that is configured for receiving the routed request, identifying the desired data protocol, and transmitting the request based on the identified desired data protocol to a model transformer. The method also includes providing the model transformer that is configured for receiving the transmitted request and performing the actual data model transformation by: accessing the data of interest in the data store and the meta data of the data of interest in the meta-data store; accessing a transformation rules database that contains rules for each specific transformation between the cloud storage data model and the desired data protocol; and determining a response based on the rules and based on existing composed information in the data store and in the meta-data store.

According to one or more of the present embodiments, the specialty of the problem of such model transformation is the need, not only to transform the structure of data, but also the relationship between data entities and semantical information.

An advantage of the present embodiments in comparison to the state of the art in this area is leverage cloud based scalability by design. This enhances the performance and cost efficiency of such a system and method. The separation between transformation logic and transformation rules allows proper scale out of many instances, based on request load. In addition, the transformation concept allows protection of investments into existing tools that work on protocol standards like OPC-UA while still preserving the benefits of the cloud internal data store (e.g., storage costs and query performance). The transformation concept also allows legacy applications running onsite to access the cloud database without any application redevelopment effort. Since one or more of the present embodiments do not only consider structural mappings like most of the solutions in the state of the art, but also includes semantics and relationship information by the meta data, complex data may be expressed as if represented in OPC-UA, BACNet, and other industrial data models.

In one embodiment, the data store is not directly accessible to the cloud based application. The meta-data store is not directly accessible to the cloud based application.

In another embodiments, the desired data protocol is a TCP (Transmission Control Protocol) or/and a UDP (User Datagram Protocol) based protocol, and the request is provided in the desired data protocol.

In a further embodiment, the model router is configured to have computing capacity, based on the cloud load balancing.

In a further embodiment, the model router is configured to identify the desired data protocol by technical attributes based on the desired data protocol. In one embodiment, the technical attributes are the port number and/or the HTTP header information and/or request structure.

In a further embodiment, the meta data includes the relationship between the data of interest stored in the data store and the required semantical information. The meta language is a language or symbols used when language itself is being discussed or examined. Metadata may, therefore, be defined as data that provides information about other data.

In the case of more than one model router, the model router that receives the request handles the upcoming data exchange between the application and the specific model transformer.

In another embodiment, the transformation rules include information such as data structure mappings from the cloud storage data model to the desired protocol in a desired data model structure, data semantics mappings from the cloud storage data model semantics to the desired model semantics, data relationship mappings from the cloud storage data model relationships to the desired model relationships, reduction rules if the desired data model does not support the same expressiveness (e.g., for relations), reduction rules if the cloud storage data model does not support the same expressiveness as the desired data model, or any combination thereof.

For example: Two data models may describe data differently and to a different level of detail. A one-to-one mapping between these data models may not be 100%. In this case, the reduction rules help to interpolate/guess missing data when data from one data model is transformed to another data model. For example, the OPC-UA data model supports an attribute (e.g., data quality). Data quality indicates the extent of correctness of a particular data field/variable. Consider there is another data model that does not support the data quality attribute. When the data is transformed from this data model to the OPC-UA data model, reduction rules may be used to infer/estimate the attribute Data Quality for the OPC-UA data model.

In another embodiment, the model transformer is configured to fetch the rules from the rule database and/or fetch all required data from the data store based on the demand of the application and/or fetch all associated meta data of the data of interest from the meta-data store and/or generate a response based on the data of interest in the format of the requested data model based on the rules.

### BRIEF DESCRIPTION OF THE DRAWINGS

FIG. 1 shows a common cloud data model of the prior art;

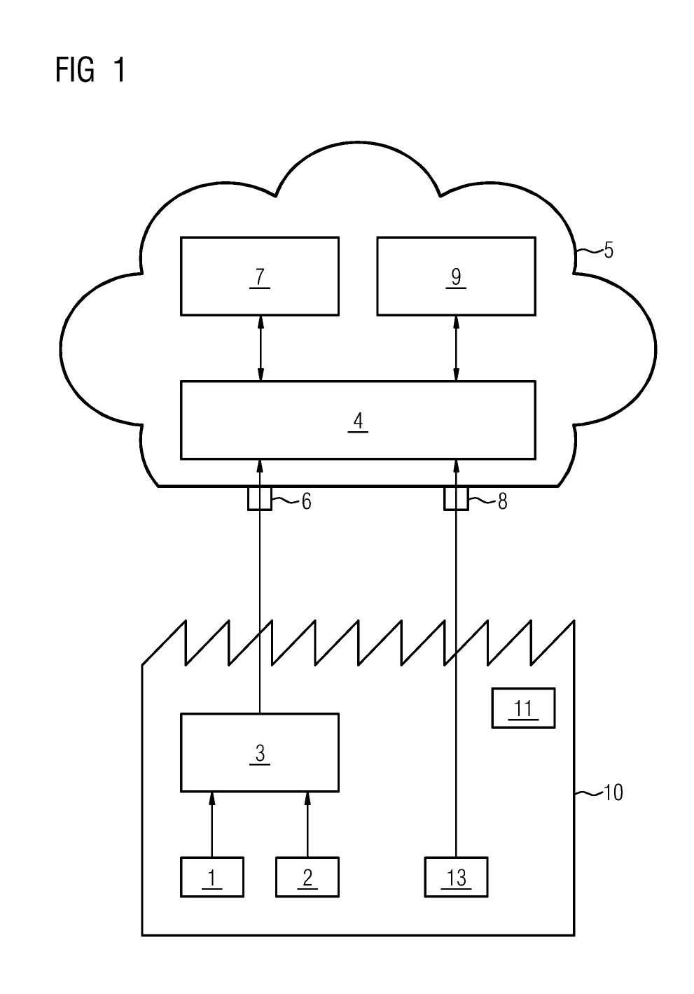

FIG. 2 shows a first embodiment of an application;

FIG. 3 shows a second embodiment of an application;

FIG. 4 shows a third embodiment of an application; and

FIG. 5 shows a diagram illustration an exposition of an exemplary data model.

### DETAILED DESCRIPTION

Although the invention has been illustrated and described in detail with reference to the exemplary embodiments, the invention is not limited to the examples disclosed. Other variations may be derived therefrom by the person skilled in the art without departing from the protective scope of the invention.

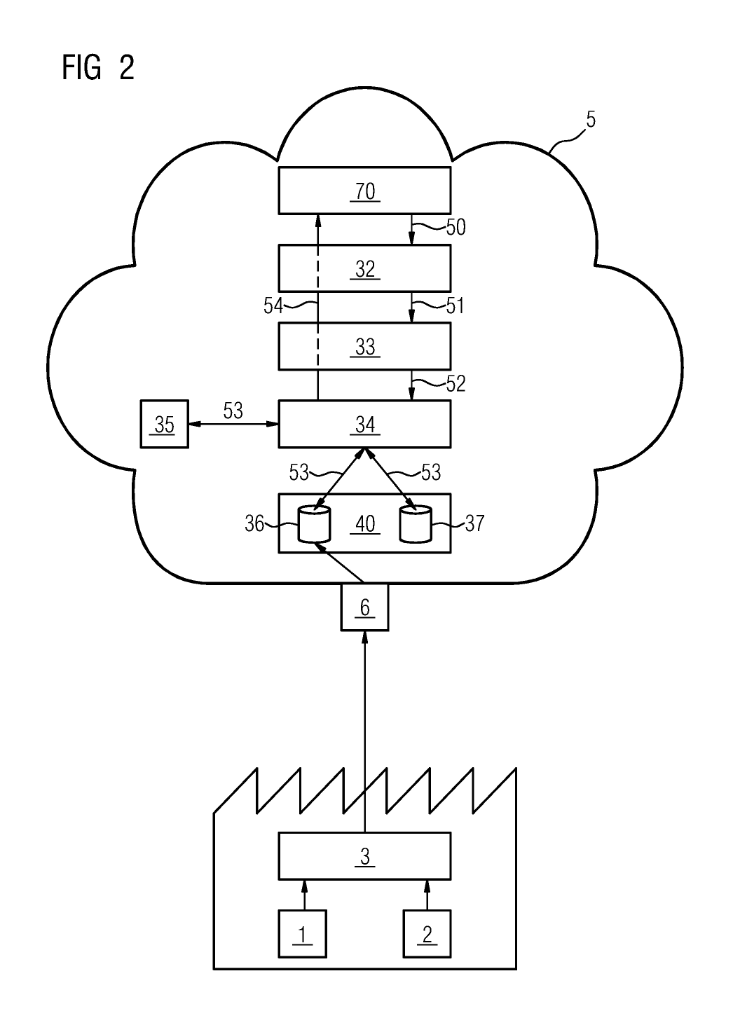

FIG. 2 shows an application that is ported to the cloud as application 70, without being re-developed so as to use the cloud data standard, instead using the OPC data standard from the agent 3.

The data is collected via a data-collection-agent 3, then transmitted to a proprietary-interface 6. Afterwards, the data is transmitted to a common cloud data model 4. At the common cloud data model 4, the data (e.g., data of interest 36) is stored in the data store in the generic cloud-storage data model of the common cloud data model 40.

FIG. 2 shows a cloud based application 70 that wants to query some data of interest 36 that is stored in the data store. The data of interest 36 is stored in the generic cloud-storage data model. The cloud-storage data model with the data of interest 36 is hidden to the cloud based application 70 and not directly accessible.

The structure of the data of interest 36, the relationship between data entities, and required semantical information by a meta data 37 are stored in a meta-data store that is also not directly accessible via the cloud based application 70.

The cloud based application 70 sends a request (arrow 50) in the desired data protocol (e.g., OPC-UA DA, MODBUS, BACNet, etc.) to a service endpoint (e.g., load balancer 32). There is technically no limitation of the selected protocol. In one embodiment, the selected protocol is a UDP or TCP based protocol.

The load balancer 32 primarily is a cloud infrastructure that is able to route (arrow 51) the request to a model router 33 that has computing capacity. The computing capacity may be based on cloud load balancing. The model router 33 identifies the desired data protocol and transmits (arrow 34) the request based on the identified desired data protocol to a model transformer 34.

The model router 33 has is able to determine the incoming request protocol format by typical technical attributes. The technical attributes depend on a chosen protocol (e.g., port number, HTTP header information, request structure).

Based on the identified protocol, the request is forwarded to a specific model transformer 34, which is specialized to transform the requested data into the chosen protocol and data model. There will thus be at least one specific transformer for each available desired data model. If the number of model transformers is scaled out, a new instance may be created, if there is no free capacity. If there are too many model routers 33 in a cloud infrastructure, the one instance that receives the request will handle the upcoming data exchange between the application 70 and the requested data.

The model router 33 identifies the desired data protocol and transmits the request based on the identified desired data protocol to a suitable model transformer 34.

The specific model transformer 34 performs the actual data model transformation and compiles a response (arrow 54) for the cloud based application 70. The specific model transformer 34 includes the following capabilities.

The specific model transformer 34 is able to access the data of interest 36 in the generic cloud-storage data model and the associated meta-data 37. The specific model transformer 34 also has access (arrow 53) to a transformation rule database 35 that contains rules for each specific transformation between the cloud data model and the concrete requested data model. Since the system is hosted in a scalable cloud environment, the number of model transformer 34 instances may be scaled out in a flexible, demand driven way. Thus, all instances of the transformers 34 are to be able to work on the same rule sets, and this leads to a separate rules data transformation rules database 35.

Based on the rules 35 (arrow 53), the model transformer 34 is able to determine how a response (arrow 54) is to be composed based on the existing information of the data of interest 36 (arrow 53), stored in the data store in the generic cloud-storage data model, and semantical meta data 37 information in the meta-data store (arrow 53).

The transformation rules include, for example, at least information about data structure mappings from the cloud storage data structure to the desired model structure and/or data semantics mappings from the data store semantics to the desired model semantics. In addition or alternatively, the transformation rules include, for example, information about data relationship mappings from the cloud storage data relationships to the desired model relationships. The transformation rules include, in addition or alternatively, information about rules reduction if the desired data model does not support the same expressiveness (e.g., for relations). This is, for example, if the desired data model is not able to express a “contains” relationship between two data points. The transformation rules include, in addition or alternatively, information about rules reduction if the cloud data model does not support the same expressiveness as the desired data model.

This provides, for example, that the model transformer makes the data structure mappings from the cloud data model to the target data model (e.g., OPC-UA). In this process, the model transformer may also use reduction rules (e.g., to interpolate the missing information in the target data model). The interpolation rules will be specific to the target data model (e.g., OPC-UA). An example where reduction rules will be applied is to generate a ‘data quality’ parameter for the OPC-UA data model in case this parameter is not present in the cloud data model.

The actual transformation model 34 includes at least the following acts: the rules are fetched from the rule database 35; based on the demand of the cloud based application, all required data is fetched from the cloud data store; meta (e.g., semantic) data associated with all data of interest 36 is fetched from the meta-data store; and based on the rules in the rule database 35, the model transformer 34 generates with the data of interest 36 a response in the format of the requested data model.

For example, consider that the application requests data is in the form of OPC-UA data model. The rules database 35 includes rules for transforming data from the cloud data model to the OPC-UA data model. The semantic data along with the data from the cloud data store is combined together based on the data transformation rules by the model transformer to generate a response in the OPC-UA format for the application.

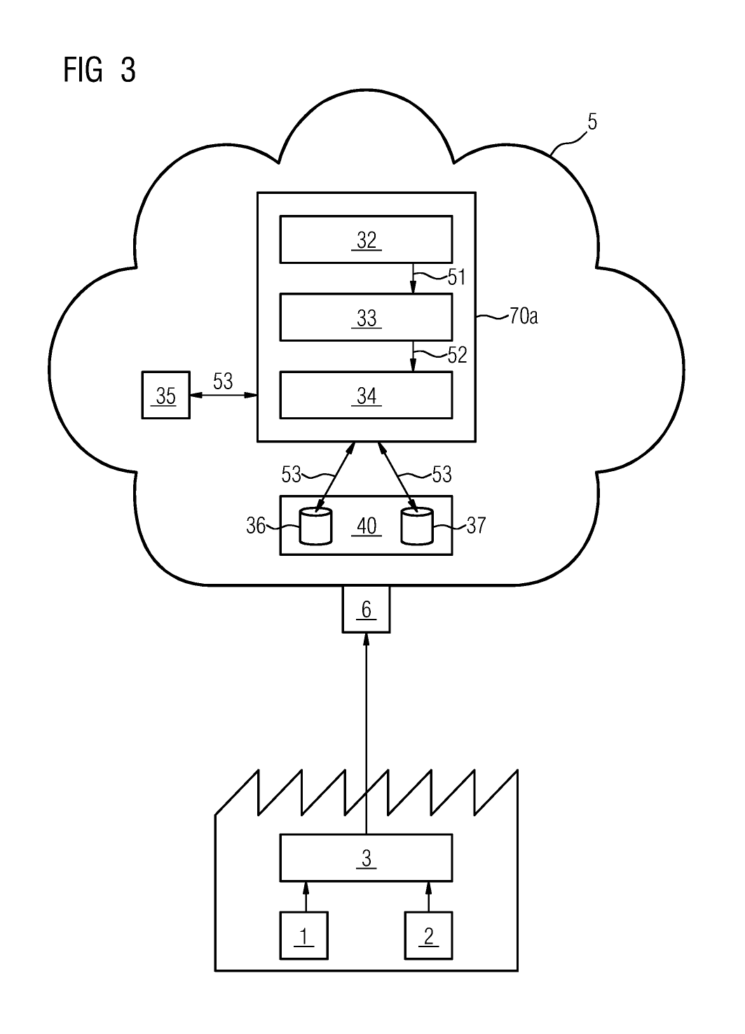

FIG. 3 shows a second embodiment, in which the model transformer 34, the load balancer 32, and the model router 33 are directly integrated in the cloud-based application 70a.

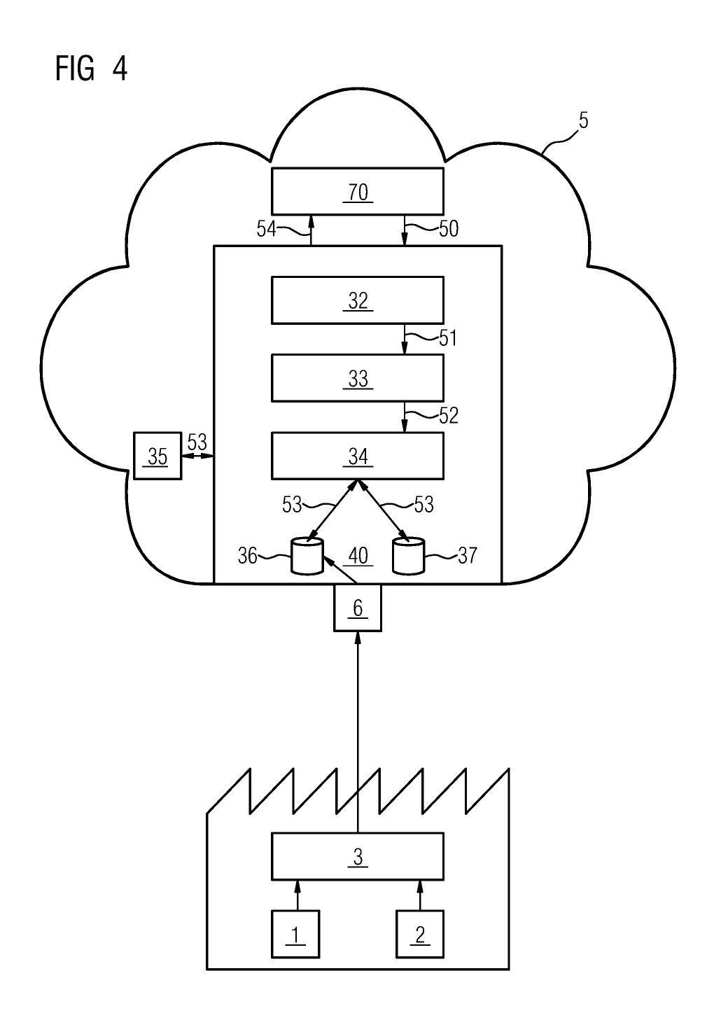

FIG. 4 shows a third embodiment, in which the model transformer 34, the load balancer 32, and the model router 33 are directly integrated into the common cloud data model 40a. These are examples that do not rule out other embodiments.

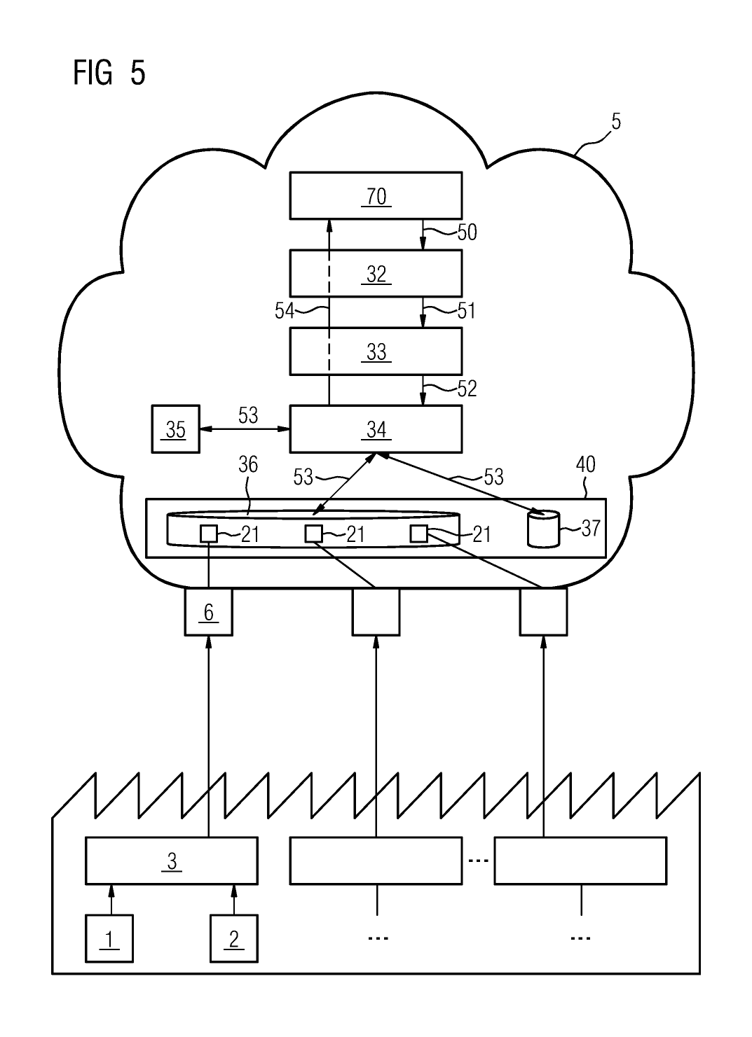

An exemplary diagram of an exposition of a data model according to an embodiment is illustrated in FIG. 5.

The common cloud data model 40 is exposed in a wide range of data model specific views. FIG. 5 shows the exposed data model 40, 40a and the exposed application 70, 70a, which, for example, are exposed with OPC-UA protocol 21 for applications 70, 70a that are compatible with the OPC-UA protocol. FIG. 5 also shows the same data model 40,40a and the application 70, 70a exposed with BACNet protocol 21 for BACNet applications 70, 70a compatible with BACNet protocol. FIG. 5 shows the same data model 40, 40a and the application 70, 70a exposed for ISO 15926 protocol 21 for ISO 15926 applications 70, 70a compatible with ISO 15926 protocol. FIG. 5 shows the same data model 40, 40a and the application 70, 70a exposed for Modbus protocol 21 for Modbus data model 40, 40a and the exposed application 70, 70a compatible with Modbus protocol. FIG. 5 shows the same data model 40, 40a and the application 70, 70a exposed for OPC protocol 21 for OPC data model 40,40a and the application 70, 70a compatible with OPC protocol, etc.

The applications 70, 70a that access data based on different protocols may not only be in the cloud, but also may be running onsite (e.g., locally) in the production automation unit. The applications 70, 70a may also be running in a separate (e.g., third party) cloud.

Business will benefit from such a solution by supporting re-use of existing legacy tools and so safeguard these investments. At the same time, such a solution allows cost-optimized big data storage based on cloud technology. With this, the innovative cloud infrastructure may be combined with legacy tool support. This lowers the entry barrier for application developers to readily make applications compatible to the cloud.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A system configured to execute data model transformations on data for cloud based applications, the system comprising:
a computer device with a cloud infrastructure having a data store, the data store having data of interest, the data of interest being stored in a cloud storage data model;
a cloud based application that is configured to query the data of interest by a request in a desired data protocol based on a desired data model structure;
a meta-data store that comprises at least meta data of the data of interest;
a load balancer with a cloud infrastructure, the load balance being configured to receive the request and for routing the request,
a model router that is configured to:
receive the routed request;
identify the desired data protocol; and
transmit the request based on the identified desired data protocol to a model transformer;
the model transformer, which is configured to receive the transmitted request and perform the data model transformation, the performance of the data model transformation comprising:
access of the data of interest in the data store and the meta data of the data of interest in the meta-data store;
access a transformation rules database that contains rules for each specific transformation between the cloud storage data model and the desired data protocol; and
determination of a response based on the rules and based on existing composed information in the data store and in the meta-data store.

2. The system of claim 1, wherein the data store is not directly accessible to the cloud based application.

3. The system of claim 1, wherein the meta-data store is not directly accessible to the cloud based application.

4. The system of claim 1, wherein the desired data protocol is a Transmission Control Protocol, a User Datagram Protocol, or the Transmission Control Protocol and the User Datagram Protocol.

5. The system of claim 1, wherein the request is provided in the desired data protocol.

6. The system of claim 1, wherein the model router is configured to have computing capacity.

7. The system of claim 1, wherein the model router is configured to identify the desired data protocol by technical attributes based on the desired data protocol.

8. The system of claim 7, wherein the technical attributes are a port number, HTTP header information, a request structure, or any combination thereof.

9. The system of claim 1, wherein the meta data comprises a relationship between the data of interest stored in the data store and the required meta data information.

10. The system of claim 1, further comprising at least one additional model router, a model router of the model router and the at least one additional model router that receives the request handling an upcoming data exchange between the cloud based application and the specific model transformer.

11. The system of claim 1, wherein at least one specific model transformer is provided for each available desired protocol.

12. The system of claim 1, wherein the transformation rules comprise data structure mappings from the cloud storage data model to the desired protocol in a desired data model structure, data semantics mappings from the cloud storage data model semantics to the desired model semantics, data relationship mappings from the cloud storage data model relationships to the desired model relationships, reduction rules when the desired data model does not support a same expressiveness, reduction rules when the cloud storage data model does not support the same expressiveness as the desired data model, or any combination thereof.

13. The system of claim 1, wherein the model transformer is configured to fetch the rules from the rule database.

14. The system of claim 1, wherein the model transformer is configured to fetch all required data from the data store based on the demand of the cloud based application.

15. The system of claim 1, wherein the model transformer is configured to fetch all associated meta data of the data of interest from the meta-data store.

16. The system of claim 1, wherein the model transformer is configured to generate a response in the format of the requested data model based on the rules.

17. A method configured to execute data model transformations on data for cloud based applications, the method comprising:
providing a computer device with a cloud infrastructure having a data store;
providing data of interest in the data store, the data of interest being stored in a cloud storage data model;
providing a cloud based application that is configured to query the data of interest by a request in a desired data protocol based on a desired data model structure;
providing a meta-data store that at least comprises the meta data of the data of interest;
providing a load balancer with a cloud infrastructure that is configured for receiving the request and for routing the request;
providing a model router that is configured for receiving the routed request, identifying the desired data protocol, and transmitting the request based on the identified desired data protocol to a model transformer;
providing the model transformer that is configured for receiving the transmitted request and performing the data model transformation, the performing of the data model transformation comprising:
accessing the data of interest in the data store and the meta data in the meta-data store;
accessing a transformation rule database that contains rules for each specific transformation between the cloud storage data model and the desired data protocol;
determining a response based on the rules and based on existing composed information in the data store and in the meta-data store.

18. The method of claim 17, wherein there is no direct accessibility from the cloud based application to the data store.

19. The method of claim 17, wherein there is no direct accessibility from the cloud based application to the meta-data store.

20. The method of claim 17, further comprising providing the request in the desired data protocol.

21. The method of claim 17, wherein the model router is configured to have computing capacity.

22. The method of claim 17, further comprising identifying, by the model router, the desired data protocol by technical attributes based on the desired data protocol.

23. The method of claim 17, wherein the transformation rules comprise providing data structure mappings from the cloud storage data model to the desired protocol in a desired data model structure, providing data semantics mappings from the cloud storage data model semantics to the desired model semantics, providing data relationship mappings from the cloud storage data model relationships to the desired model relationships, reducing the rules when the desired data model does not support the same expressiveness, reducing the rules when the cloud data storage model does not support the same expressiveness as the desired data model, or any combination thereof.

24. The method of claim 17, wherein the rules are fetched from the rule database.

25. The method of claim 17, wherein based on the demand of the cloud based application, all required data is fetched from the data store.

26. The method of claim 17, wherein all associated data is fetched from the meta-data store.

27. The method of claim 17, wherein based on the rules, the model transformer is configured to generate a response in the format of the requested data model.
